(19) United States
(12) Patent Application Publication
(10) Pub. No.: US 2026/0133098 A1
(43) Pub. Date: May 14, 2026

(54) SIMULATING AND TESTING PLATFORM SYSTEM AND METHOD FOR LASER-MECHANICAL COMBINED EFFICIENT DRILLING AND ROCK BREAKING

(71) Applicant: SHANDONG UNIVERSITY, Jinan, Shandong (CN)

(72) Inventors: Bin LIU, Jinan (CN); Bo ZHANG, Jinan (CN); Biao LI, Jinan (CN); Tianliang HU, Jinan (CN); Zhongming YANG, Jinan (CN); Shaoshuai SHI, Jinan (CN); Bin XU, Jinan (CN); Xinjie HUANG, Jinan (CN)

(73) Assignee: SHANDONG UNIVERSITY, Jinan, Shandong (CN)

(21) Appl. No.: 19/478,588

(22) PCT Filed: Oct. 30, 2023
(86) PCT No.: PCT/CN2023/127959

§ 371 Date: Oct. 24, 2025

(30) Foreign Application Priority Data
Apr. 24, 2023 (CN) 202310483161.X

(51) Int. Cl. G01M 99/00; E21B 7/15; E21B 10/567

(52) U.S. Cl. CPC G01M 99/005; E21B 7/15; E21B 10/567

(57) ABSTRACT

A simulating and testing platform system for laser-mechanical combined efficient drilling and rock breaking, comprising a laser-mechanical combined drilling tool being fixed on a position adjusting device through a drilling tool carrying device to achieve adjustment of a drill hole space and a relative angle, a driving device configured to drive the drilling tool to rotate and advance to achieve a rock breaking function, and a confining pressure loading device configured to perform confining pressure loading of a sample to simulate a real terrestrial stress environment. Wherein, the position adjusting device achieves all-around and multi-angle continuous drilling; the confining pressure loading device simulates the real terrestrial stress environment to increase the combined rock breaking efficiency in a manner of biasing laser.

The present invention claims priority to Chinese Patent Application No. 202310483161.X, filed with the China National Intellectual Property Administration on Apr. 24, 2023 and entitled “SIMULATING AND TESTING PLATFORM SYSTEM AND METHOD FOR LASER-MECHANICAL COMBINED EFFICIENT DRILLING AND ROCK BREAKING”, which is incorporated herein by reference in its entirety.

### TECHNICAL FIELD

The present invention relates to the technical field of long-distance drilling and rock breaking, and in particular, to a simulating and testing platform system and method for laser-mechanical combined efficient drilling and rock breaking.

### BACKGROUND

The statements in this part merely provide the background art related to the present invention, and do not necessarily constitute the prior art.

An engineering geological drilling rig can achieve advanced drilling and core drilling functions, grasp the geological environment of the construction ahead, explore unknown geological disasters, obtain surrounding geological information, and guide engineering construction operations in time, thereby ensuring the safety construction of underground engineering. However, in underground engineering construction, long-distance geological exploration is often required. The existing advanced drilling rig takes too long in construction process, the construction period of drilling with a distance of a hundred meters exceeds one day, and it is not allowed to spend a lot of time on drilling construction in the construction site, thereby limiting the construction and application of long-distance drilling in advanced drilling. In addition, when the traditional drilling rig encounters complex conditions such as highly abrasive hard rocks, composite formations, and fractured formations, the engineering drilling efficiency sharply decreases, abnormal wear and damage of equipment and problems of stuck and buried drilling occur sometimes, and even safety accidents occur.

In this background, a new generation of auxiliary rock breaking concept based on laser, water jet, microwave, particles and other novel rock breaking methods has been proposed and has become a research hotspot and technological frontier in the international engineering drilling field. In numerous novel rock breaking methods, the laser technology has the advantages of low energy, high efficiency and easy implementation, has a relatively rich practice basis in the field of petroleum engineering, and is considered as a very promising auxiliary rock breaking method.

Research has shown that laser-assisted drilling construction can effectively improve the rock breaking efficiency, and the drilling speed can reach more than 10 times that of a traditional drilling rig. With laser assistance, the drilling efficiency can be greatly improved, the service life of a drill bit and a drill rod can also be prolonged, and the occurrence of disaster accidents such as stuck drilling and abnormal wear can be effectively avoided. Therefore, the high-energy laser-assisted rock breaking technology has very high research and application value in the field of engineering drilling.

The invention found that the existing laser-assisted drilling construction device often cannot optimize simulation tests according to specific application scenarios during design, resulting in poor integration level of the device, which cannot meet actual needs. Moreover, due to the special nature of a laser circuit and a laser head, laser rock breaking has the problems of relatively low efficiency and inadequate protection and cleaning of the laser head, which causes certain limitations to the laser-assisted rock breaking technology in specific applications.

### SUMMARY

To solve the defects of the prior art, the present invention provides a simulating and testing platform system and method for laser-mechanical combined efficient drilling and rock breaking, which can achieve all-around and multi-angle continuous drilling, really simulate a drilling state and a drilling posture of a geological drilling rig, effectively simulate a real stress environment, increase the combined rock breaking efficiency, solve the design problem of laser-mechanical integrated carrying, and solve the problems of energy transmission of laser and cleaning and protection of a laser head.

To achieve the above objectives, the present invention adopts the following technical solutions:
A first aspect of the present invention provides a simulating and testing platform system for laser-mechanical combined efficient drilling and rock breaking.

The simulating and testing platform system for laser-mechanical combined efficient drilling and rock breaking includes:
a confining pressure loading device, configured to perform sample positioning, clamping and confining pressure loading;
a laser-mechanical combined drilling tool, configured to perform laser-mechanical combined drilling;
a driving device, configured to drive the laser-mechanical combined drilling tool to perform combined drilling;
a drilling tool carrying device, configured to carry the laser-mechanical combined drilling tool and the driving device; and
a position adjusting device, configured to be connected to the drilling tool carrying device, and adjust a relative position between the laser-mechanical combined drilling tool and a sample to change a drilling angle of the laser-mechanical combined drilling tool.

As a further limitation of the first aspect of the present invention, the confining pressure loading device includes a sample base, a sample adjusting device, a confining pressure loading rock box, and a confining pressure loading mechanism.

The sample base is configured to bear the sample. The sample adjusting device is configured to push the sample to a designated position of the confining pressure loading rock box. The confining pressure loading mechanism is configured to clamp and fix the rock sample and apply a pressure to the rock sample.

As a further limitation of the first aspect of the present invention, the driving device includes a rotation loading module and a pushing force loading mechanism.

The rotation loading module includes a hydraulic motor, a reduction gearbox, a drill rod clamping device, and a power head pedestal. The drill rod clamping device is configured to be connected to the laser-mechanical combined drilling tool. The hydraulic motor is connected to the drill rod clamping device through the reduction gearbox. The reduction gearbox and the drill rod clamping device are both connected to the power head pedestal.

A first end of the pushing force loading mechanism is connected to the drilling tool carrying device, and a second end of the pushing force loading mechanism is connected to the power head pedestal. The pushing force loading mechanism is configured to apply a pushing force to act on the power head pedestal to push the power head pedestal for feeding, so as to drive the laser-mechanical combined drilling tool to advance for rock breaking.

The drilling tool carrying device includes a feeding frame and a centralizer.

The power head pedestal is slidably connected to the feeding frame and is configured to drive the laser-mechanical combined drilling tool to feed forward and move backward along the feeding frame. The centralizer is fixed at a front end of the feeding frame and is configured to clamp and centralize the laser-mechanical combined drilling tool.

As a further limitation of the first aspect of the present invention, the position adjusting device includes an angle adjusting module, a vertical position adjusting mechanism, a base, and a horizontal position adjusting mechanism.

A first end of the angle adjusting module is connected to the feeding frame, and a second end is connected to a guide sleeve. The angle adjusting module is configured to drive the drilling tool carrying device to achieve angle adjustment, so as to achieve relative drilling angle adjustment of the laser-mechanical combined drilling tool relative to the rock sample.

The vertical position adjusting mechanism includes an upright post, the guide sleeve, bolt holes, and a vertical adjusting oil cylinder.

The upright post is connected to a sliding seat. The guide sleeve sleeves the upright post. A first end of the guide sleeve is connected to the angle adjusting module. The vertical loading oil cylinder is connected to the angle adjusting module. The guide sleeve can be driven to move vertically along the upright post under a pushing effect of the vertical loading oil cylinder.

After the guide sleeve moves to a designated position, the vertical loading oil cylinder is self-locked, and the bolt holes in the guide sleeve are configured to perform secondary bolt fixation.

The horizontal position adjusting mechanism includes a sliding chute, the sliding seat, a horizontal adjusting motor, and a lead screw. The base is configured to be arranged inside a foundation pit to enable a testing device to sink below a plane of a foundation basis.

The sliding chute is fixed on the base. An upper end of the sliding chute is connected to the sliding seat. One side of the sliding seat is connected to the horizontal adjusting motor through the lead screw. The lead screw is driven to rotate under the driving of the horizontal adjusting motor to enable the sliding seat to move horizontally along the sliding chute.

The lead screw has a self-locking function, and after the sliding seat moves to a designated position, the lead screw is self-locked and fixed.

As a further limitation of the first aspect of the present invention, the laser-mechanical combined drilling tool includes a drill rod.

The drill rod includes a first-level outer rod, an outer rod variable-diameter section, a second-level outer rod, a first-level inner rod, an inner rod variable-diameter section, a second-level inner rod, a wear-resistant copper sleeve, and a support ring.

The first-level outer rod is connected to the second-level outer rod through the outer rod variable-diameter section. The first-level inner rod is connected to the second-level inner rod through the inner rod variable-diameter section. An inner diameter of the second-level outer rod is less than an inner diameter of the first-level outer rod. An inner diameter of the second-level inner rod is less than an inner diameter of the first-level inner rod. The first-level outer rod sleeves outside the first-level inner rod. The wear-resistant copper sleeve is connected between the first-level outer rod and the first-level inner rod. The support ring is arranged in the first-level inner rod.

As a still further limitation of the first aspect of the present invention, the laser-mechanical combined drilling tool further includes a drill bit.

The drill bit includes cutting teeth, reinforcing teeth, water outlet holes, and a light outlet hole. The drill bit is of a multi-wing PDC composite drill bit structure. The cutting teeth of each wing are arranged in a streamlined tooth pattern, and the reinforcing teeth are arranged in a back row of the cutting teeth of each wing.

The water outlet holes are formed between adjacent wings of the drill bit; a laser light outlet hole is formed at a position deviating from a center of the drill bit; and the cutting teeth are arranged at the center of the drill bit.

As a still further limitation of the first aspect of the present invention, the laser-mechanical combined drilling tool further includes an inner rod fine-adjusting mechanism.

The inner rod fine-adjusting mechanism includes a servo motor, a synchronous pulley, and an absolute value encoder. The second-level inner rod is connected to the servo motor through the synchronous pulley. The absolute value encoder is mounted on the synchronous pulley and is configured to record a rotation angle of the second-level inner rod in real time to adjust a rotation angle of a laser head, so as to align a laser beam with the light outlet hole of the drill bit.

As a still further limitation of the first aspect of the present invention, the laser-mechanical combined drilling tool further includes a laser head assembly.

The laser head assembly includes a laser head protection device.

The laser head protection device includes a laser head protective shell, a sapphire lens, an openable baffle, a cylinder, and a cylinder push rod.

The laser head is fixed in the laser head protective shell, and the sapphire lens is mounted outside the laser head for first-level protection. The openable baffle is mounted outside the sapphire lens, the openable baffle drives the cylinder push rod to reciprocate through the cylinder to achieve opening and closing actions, and the openable baffle constitutes second-level protection.

As a still further limitation of the first aspect of the present invention, the laser head protection device further includes a liquid cleaning module and a gas washing module.

The liquid cleaning module includes a washing water nozzle, a cleaning water pipe, and a water tank pump.

The water tank pump is configured to hold and pressurize liquid. A first end of the cleaning water pipe is connected to the water pump. The cleaning water pipe is mounted in the second-level inner rod and the inner rod variable-diameter section. A second end of the cleaning water pipe is connected to the washing water nozzle through the support ring. A spraying direction of the washing water nozzle faces the laser head.

The gas washing module includes a washing gas nozzle, a cleaning gas pipe, and a gas pump.

The gas pump is configured to generate and pressurize gas. A first end of the cleaning gas pipe is connected to the gas pump. The cleaning gas pipe is mounted in the second-level inner rod and the inner rod variable-diameter section. A second end of the cleaning gas pipe is connected to the washing gas nozzle through the support ring. A spraying direction of the washing gas nozzle faces the laser head.

As a still further limitation of the first aspect of the present invention, the laser head protection device further includes a sealing module.

The sealing module is arranged outside the sapphire lens and is configured to seal the laser head protection mechanism.

As a still further limitation of the first aspect of the present invention, the system further includes a slag discharging liquid pipeline.

The slag discharging liquid pipeline includes a water pump tank, a slag discharging water pipe, and the water outlet holes.

A first end of the slag discharging water pipe is connected to the water pump tank, and the slag discharging water pipe is arranged in the second-level inner rod and the inner rod variable-diameter section, and is transmitted to the outside of a laser head protective shell through the support ring and then connected to the water outlet holes, so as to enable the liquid to be discharged through the water outlet holes and then carry rock slag and rock debris to return from the outside of the first-level outer rod.

A second aspect of the present invention provides a simulating and testing method for laser-mechanical combined efficient drilling and rock breaking.

The simulating and testing method for laser-mechanical combined efficient drilling and rock breaking includes:
closing an openable baffle, a laser head being in a sealed protection state, driving a drill rod through a driving device to drive a drill bit to perform mechanical cutting for drilling and rock breaking, introducing slag discharging liquid into a slag discharging water pipe for discharging slag, stopping the driving device after the drill bit drills to a designated position, enabling a laser-mechanical combined drilling tool to stop rotating, and turning off a water pump to stop introducing the slag discharging liquid;
opening the openable baffle, cleaning a sapphire lens through a washing water nozzle, rinsing dust adhered to the sapphire lens, then turning off the water pump to enable the washing water nozzle to stop rinsing, turning on a gas pump, blowing off water droplets on the sapphire lens through a washing gas nozzle, and then turning on a laser device to perform a laser rock breaking test; and
repeating the processes to achieve a laser-mechanical combined drilling and rock breaking test.

As a further limitation of the second aspect of the present invention, a rock sample is hoisted to a sample base and moved into a confining pressure loading rock box through a sample adjusting device, and when the laser-mechanical combined drilling tool performs a drilling and rock breaking test, a confining pressure loading mechanism applies confining pressures with predetermined magnitudes to the rock sample to simulate terrestrial stress situations at different burial depths.

Compared with the prior art, the present invention has the following beneficial effects:
1. The present invention innovatively provides the simulating and testing platform system and method for laser-mechanical combined efficient drilling and rock breaking. All-around and multi-angle continuous drilling is achieved through a position adjusting device to more really simulate a drilling state and a drilling posture of a geological drilling rig.
2. The present invention innovatively provides the simulating and testing platform system and method for laser-mechanical combined efficient drilling and rock breaking. A real terrestrial stress environment is simulated through the confining pressure loading device, which can not only really simulate a rock breaking terrestrial stress environment, but also be used for positioning and fixing of the rock sample.
3. The present invention innovatively provides the simulating and testing platform system and method for laser-mechanical combined efficient drilling and rock breaking. By means of biasing laser, a light spot rock breaking area is increased, and the combined rock breaking efficiency is improved.
4. The present invention innovatively provides the simulating and testing platform system and method for laser-mechanical combined efficient drilling and rock breaking. A structural form of multiple pipes in pipes solves the design problem of laser-mechanical integrated carrying.
5. The present invention innovatively provides the simulating and testing platform system and method for laser-mechanical combined efficient drilling and rock breaking. The problems of energy transmission of laser and cleaning and protection of the laser head are solved through optimization of pipeline arrangement in the drill rod.
6. The present invention innovatively provides the simulating and testing platform system and method for laser-mechanical combined efficient drilling and rock breaking. The protective cover with the sapphire lens is mounted outside the laser head, and the openable baffle is mounted outside the sapphire lens. When laser irradiation starts, the openable baffle is opened, and then, the laser head emits a laser beam. After the laser irradiation ends, the openable baffle is closed to prevent the laser head from being damaged by splashing rock slag in front of the drill bit during drilling and rock breaking, thereby achieving two-level protection for the laser head.
7. The present invention innovatively provides the simulating and testing platform system and method for laser-mechanical combined efficient drilling and rock breaking. After the drill bit breaks the rock, first, high-pressure water is used for rinsing dust and debris on the sapphire lens, and then, high-pressure gas is used for blow-drying water stains on the lens, thereby ensuring that the lens is dry and clean, and avoiding affecting the transmission of optical paths and burning out the lens.
8. The present invention innovatively provides the simulating and testing platform system and method for laser-mechanical combined efficient drilling and rock breaking. The laser head is arranged in the inner rod, and a tail end of the inner rod is connected to the servo motor and the absolute value encoder. When the outer rod drives the drill bit to rotate for rock breaking, the inner rod is fixed. After the rock breaking stops, the inner rod finds the position of the light outlet hole of the drill bit by the absolute value encoder, thereby ensuring smooth emission of laser, and achieving multi-point irradiation of laser on the rock sample.
9. The present invention innovatively provides the simulating and testing platform system and method for laser-mechanical combined efficient drilling and rock breaking. The centralizer is arranged at the front end of the drilling tool carrying platform and is configured to clamp the laser-mechanical combined drilling tool, thereby reducing radial vibration generated during drilling and rock breaking of the laser-mechanical combined drilling tool, and improving the drilling accuracy.
10. The present invention innovatively provides the simulating and testing platform system and method for laser-mechanical combined efficient drilling and rock breaking. The base and the position adjusting device are both located inside the foundation pit, and a bottom end of the confining pressure applying module is arranged on a surface of the foundation pit, so that the sample can be placed on the foundation plane during a test process to reduce the risk caused by large sample hoisting.
11. The present invention innovatively provides the simulating and testing platform system and method for laser-mechanical combined efficient drilling and rock breaking. The first-level outer rod is connected to the second-level outer rod through the outer rod variable-diameter section to achieve diameter reduction of the first-level outer rod. The first-level inner rod is connected to the second-level inner rod through the inner rod variable-diameter section to achieve diameter reduction of the first-level inner rod. Due to the diameter reduction of the drill rod, on the one hand, the spacing between a hole wall and an outer wall of the drill rod is increased, which is favorable for discharging slag; and on the other hand, the costs can also be reduced.
12. The present invention innovatively provides the simulating and testing platform system and method for laser-mechanical combined efficient drilling and rock breaking. The drill bit is of the multi-wing PDC composite drill bit structure, the cutting teeth of each wing are arranged in a streamlined tooth pattern, and the reinforcing teeth are arranged in the back row of the cutting teeth of each wing to improve the stress on the drill teeth. A plurality of water outlet holes are formed between wings of the drill bit to ensure a sufficient flow of slag discharging liquid for discharging slag. The laser light outlet hole is formed at the position deviating from the center of the drill bit, and the cutting teeth are arranged at the center of the drill bit to ensure the smooth cutoff of a central rock pillar.

### BRIEF DESCRIPTION OF THE DRAWINGS

The accompanying drawings of the specification, constituting a part of the present invention, are used for providing a further understanding for the present invention. Exemplary embodiments of the present invention and descriptions thereof are used for explaining the present invention, but do not constitute any improper limitation on the present invention.

FIG. 1 is a schematic 3D structure view of a simulating and testing platform system for laser-mechanical combined efficient drilling and rock breaking provided in Example 1 of the present invention;

FIG. 2 is a schematic three-dimensional (3D) structure view of a confining pressure loading device shown in FIG. 1;

FIG. 3 is a schematic 3D structure view of a position adjusting device shown in FIG. 1;

FIG. 4 is a cross-sectional view of a laser-mechanical combined drilling tool shown in FIG. 1;

FIG. 5 is a schematic structural view of a drill bit shown in FIG. 4;

FIG. 6 is a schematic structural view of a laser head protection device shown in FIG. 4;

FIG. 7 is a schematic view of a plug sealing structure at a tail end of a second-level inner rod shown in FIG. 4; and

FIG. 8 is a schematic 3D structure view of a driving device shown in FIG. 1.

In the drawings:
1, foundation basis;
2, confining pressure loading device; 21, rock sample; 22, sample base; 23, sample adjusting device; 24, confining pressure loading rock box; 25, confining pressure loading oil cylinder;
3, position adjusting device; 31, horizontal position adjusting mechanism; 311, T-shaped groove; 312, sliding seat; 313, horizontal adjusting motor; 314, lead screw; 32, vertical position adjusting mechanism; 321, upright post; 322, guide sleeve; 323, bolt hole; 324, vertical adjusting oil cylinder; 33, angle adjusting module;
4, laser-mechanical combined drilling tool; 41, drill bit; 411, cutting teeth; 412, reinforcing teeth; 413, water outlet hole; 414, light outlet hole; 42, drill rod; 421, first-level outer rod; 422, outer rod variable-diameter section; 423, second-level outer rod; 424, first-level inner rod; 425, inner rod variable-diameter section; 426, second-level inner rod; 427, wear-resistant copper sleeve; 428, support ring; 43, laser head assembly; 431, laser head; 432, laser head protective shell; 433, sapphire lens; 434, openable baffle; 435, cylinder gas pipe; 436, cylinder; 437, cylinder push rod; 438, washing water nozzle; 439, washing gas nozzle; 44, inner rod fine-adjusting mechanism; 441, servo motor; 442, synchronous pulley; 443, absolute value encoder; 45, plug structure; 451, slag discharging water pipe; 452, laser head cooling water pipe; 453, laser fiber; 454, high-pressure gas pipe; 455, cleaning water pipe; 456, cleaning gas pipe; 461, gas pump; 462, laser device; 463, water tank pump;
5, driving device; 51, rotation loading module; 511, hydraulic motor; 512, reduction gearbox; 513, drill rod clamping mechanism; 514, power head pedestal; 52, pushing force loading oil cylinder;
6, drilling tool carrying device; 61, feeding frame; 62, centralizer;
7, oil source pump station; 71, pump station; 72, oil cooling box;
8, base;
9, foundation pit; and
10, control cabinet.

### DETAILED DESCRIPTION

The present invention is further described below with reference to the accompanying drawings and embodiments.

It should be noted that the following detailed descriptions are all exemplary and are intended to provide a further description of the present invention. Unless otherwise specified, all technical and scientific terms used in the present invention have the same meanings as commonly understood by those skilled in the art of the present application.

It should be noted that the terms used herein are merely used for describing specific implementations, but are not intended to limit exemplary implementations according to the present invention. As used herein, unless explicitly stated in the context, the singular form is also intended to include the plural form. In addition, it should also be understood that when the terms “comprise” and/or “include” are used in the specification, they indicate the presence of features, steps, operations, devices, components, and/or combinations thereof.

In the case of no conflict, the embodiments in the present invention and the features in the embodiments may be combined with each other.

### Example 1

Example 1 of the present invention provides a simulating and testing platform system for laser-mechanical combined efficient drilling and rock breaking, which includes:
a foundation basis 1;
a confining pressure loading device 2, where the confining pressure loading device 2 is configured to perform positioning and mounting, clamping and fixing, and confining pressure loading of a rock sample 21;
a driving device 5;
a laser-mechanical combined drilling tool 4, where the laser-mechanical combined drilling tool 4 is connected to a drill rod clamping mechanism 513 of the driving device 5;
a drilling tool carrying device 6, where the drilling tool carrying device 6 is configured to carry the laser-mechanical combined drilling tool 4 and the driving device 5; and
a position adjusting device 3, where the drilling tool carrying device 6 is connected to the position adjusting device 3, and the position adjusting device 3 can adjust a spatial position of the drilling tool carrying device 6, so as to adjust a relative position between the laser-mechanical combined drilling tool 4 and the rock sample 21 to change a drilling angle of the laser-mechanical combined drilling tool 4.

In the present embodiment, the position adjusting device 3 can adjust any position and any angle of the drilling tool carrying device 6 in space, thereby achieving all-around and multi-angle drilling of the laser-mechanical combined drilling tool 4 to simulate a drilling state and a drilling posture of an engineering drilling rig during actual drilling.

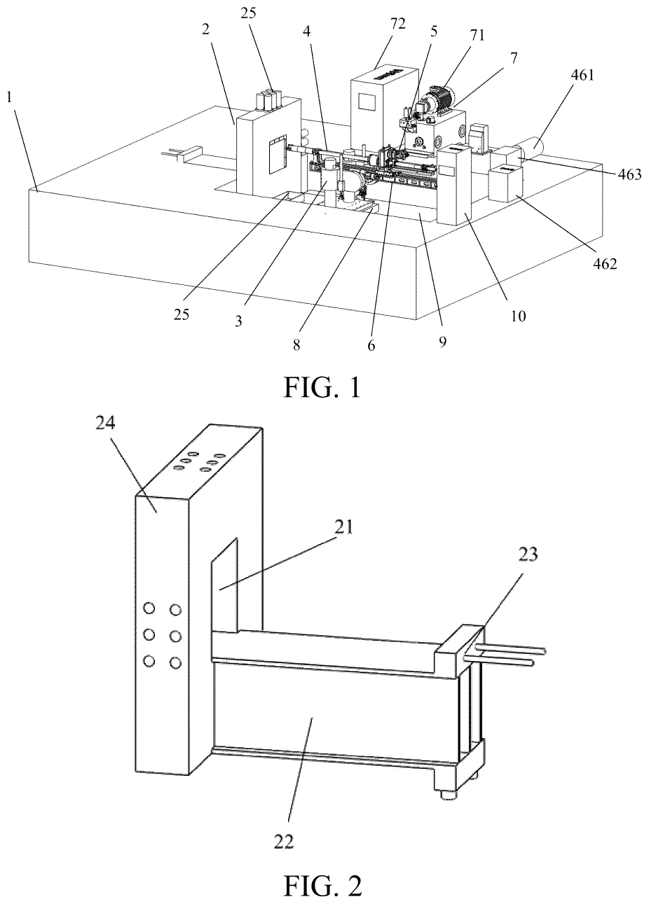

In some implementations of the present invention, as shown in FIG. 1 and FIG. 2, the confining pressure loading device 2 includes a rock sample 21, a sample base 22, a sample adjusting device 23, a confining pressure loading rock box, and a confining pressure loading oil cylinder 25.

After the rock sample 21 is hoisted to the sample base 22, the sample adjusting device 23 pushes the rock sample 21 to a designated position of the confining pressure loading rock box 24. Under the effect of the confining pressure loading oil cylinder 25, the rock sample 21 is clamped and fixed to ensure that the rock sample 21 does not generate displacement during a drilling test, which may affect the drilling accuracy.

Furthermore, a pressure value of the confining pressure loading oil cylinder 25 can be adjusted, so as to achieve loading of different confining pressure levels to perform a combined drilling and rock breaking test under confining pressure conditions.

In some implementations of the present invention, as shown in FIG. 1 and FIG. 8, the driving device 5 includes a rotation loading module 51. The rotation loading module 51 includes a hydraulic motor 511, a reduction gearbox 512, a drill rod clamping device 513, and a power head pedestal 514.

The laser-mechanical combined drilling tool 4 is clamped and enclasped by the drill rod clamping device 513, and the rotary power provided by the hydraulic motor 511 is transmitted to the laser-mechanical combined drilling tool 4 through the reduction gearbox 512 and the drill rod clamping device 513, so as to achieve rotary cutting of the laser-mechanical combined drilling tool 4 for rock breaking. The reduction gearbox 512 and the drill rod clamping device 513 are connected to the power head pedestal 514.

In some implementations of the present invention, as shown in FIG. 1 and FIG. 8, the driving device 5 includes a pushing force loading oil cylinder 52. A first end of the pushing force loading oil cylinder 52 is fixed on the drilling tool carrying device 6, and a second end of the pushing force loading oil cylinder 52 is connected to the power head pedestal 514. The pushing force loading oil cylinder 52 applies a pushing force to act on the power head pedestal 514 to push the power head pedestal 514 for feeding, so as to drive the laser-mechanical combined drilling tool 4 to advance for rock breaking.

In some implementations of the present invention, as shown in FIG. 4, a drill rod 42 includes a first-level outer rod 421, an outer rod variable-diameter section 422, a second-level outer rod 423, a first-level inner rod 424, an inner rod variable-diameter section 425, a second-level inner rod 426, a wear-resistant copper sleeve 427, and a support ring 428.

The drill rod 42 has a structural form of “multiple pipes in pipes”. The first-level outer rod 421 is configured to transmit a pushing force and a torque; the first-level inner rod 424 is configured to fix a laser head protective shell 432; and the wear-resistant copper sleeve 427 is arranged between the first-level outer rod 421 and the first-level inner rod 424, thereby solving the problem of dynamic and static separation between the inner and outer rods.

The drill rod 42 has multi-level variable diameters. The first-level outer rod 421 is connected to the second-level outer rod 423 through the outer rod variable-diameter section 422 to achieve diameter reduction of the first-level outer rod 421. The first-level inner rod 424 is connected to the second-level inner rod 426 through the inner rod variable-diameter section 425 to achieve diameter reduction of the first-level inner rod 424. Due to the diameter reduction of the drill rod 42, on the one hand, the spacing between a hole wall and an outer wall of the drill rod is increased, which is favorable for discharging slag; and on the other hand, the costs can also be reduced.

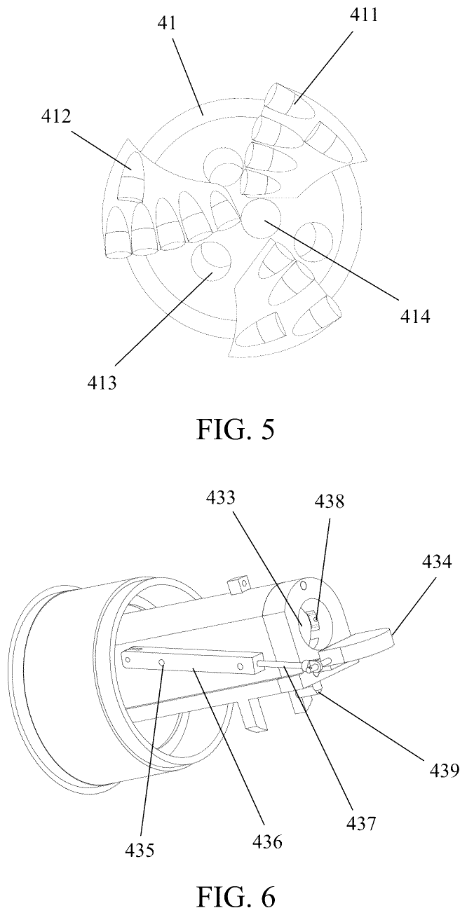

In some implementations of the present invention, as shown in FIG. 4 and FIG. 5, a drill bit 41 includes cutting teeth 411, reinforcing teeth 412, water outlet holes 413, and a light outlet hole 414. The drill bit 41 is of a multi-wing PDC composite drill bit structure. The cutting teeth 411 of each wing are arranged in a streamlined tooth pattern, and the reinforcing teeth 412 are arranged in a back row of the cutting teeth 411 of each wing to improve the stress on the drill teeth.

A plurality of water outlet holes 413 are formed between wings of the drill bit 41 to ensure a sufficient flow of slag discharging liquid for discharging slag. The laser light outlet hole 414 is formed at a position deviating from a center of the drill bit 41, and the cutting teeth 411 are arranged at the center of the drill bit 41 to ensure the smooth cutoff of a central rock pillar.

In some implementations of the present invention, as shown in FIG. 4 and FIG. 5, the laser head protective shell 432 is fixed on the first-level inner rod 424, and the light outlet hole 414 deviates from the center of the drill bit 41. The cutting teeth 411 are arranged at the center of the drill bit 41, and the central cutting teeth 411 can cut off the central rock pillar to ensure continuous drilling of the drilling rig.

In some implementations of the present invention, as shown in FIG. 4, this test platform adopts a step-by-step rock breaking manner. The laser first irradiates the rock sample 21, and then, the drill bit 41 performs cutting for rock breaking. When the first-level outer rod 421 drives the drill bit 41 for rock breaking, the first-level inner rod 424 is fixed. After the first-level outer rod 421 and the drill bit 41 stop rotating, the first-level inner rod 424 needs to drive a laser head 431 to align with the light outlet hole 414 of the drill bit 41, so as to ensure that high-energy laser can be smoothly emitted to the rock sample 21 for laser rock breaking. In this case, an inner rod fine-adjusting mechanism 44 is required to adjust a rotation angle of the inner rod, so as to ensure that the laser can be emitted from the light outlet hole 414 of the drill bit 41.

In some implementations of the present invention, as shown in FIG. 4 and FIG. 8, the inner rod fine-adjusting mechanism 44 includes a servo motor 441, a synchronous pulley 442, and an absolute value encoder 443. The second-level inner rod 426 is connected to the servo motor 441 through the synchronous pulley 442. The absolute value encoder 443 is mounted on the synchronous belt 442 to record a rotation angle of the second-level inner rod 426 in real time to finally achieve accurate adjustment of a rotation angle of the laser head 431, so as to align a laser beam with the light outlet hole 414 of the drill bit 41. The first-level outer rod 421 cooperates with the first-level inner rod 424 to achieve multi-point irradiation of laser on the rock sample 21.

In some implementations of the present invention, as shown in FIG. 4 and FIG. 6, the reference number 43 represents a laser head assembly, and the reference number 431 represents a laser head. The laser head protection device includes a laser head protective shell 432, a sapphire lens 433, an openable baffle 434, a cylinder 436, and a cylinder push rod 437.

The laser head 431 is fixed in the laser head protective shell 432 through bolts, and the sapphire lens 433 is mounted outside the laser head 431 for first-level protection. Specifically, the sapphire lens 433 has higher strength and the wear resistance and can effectively resist rock slag, rock debris, and the like during drilling and rock breaking processes.

The openable baffle 434 is mounted outside the sapphire lens 433, and the openable baffle 434 drives the cylinder push rod 437 to reciprocate through the cylinder 436 to achieve opening and closing actions, so as to prevent rock slag and the like from entering the laser head protective shell 432 and damaging the lens assembly, thereby constituting second-level protection.

The opening and closing of the openable baffle 434 in the laser head protection device need to be controlled according to a rock breaking state. When the drill bit 41 performs rock breaking, the cylinder push rod 437 drives the openable baffle 434 to close, and in this case, the rock slag and dust generated by the rock breaking of the drill bit 41 cannot enter the laser head protective shell 432, so as to play a role in protecting the laser head 431. When the drill bit 41 stops working and starts laser rock breaking, the cylinder push rod 437 drives the openable baffle 434 to open, so that the laser can smoothly pass through the light outlet hole 414 of the drill bit 41.

In some implementations of the present invention, during the cyclic use of the sapphire lens 433, dust is easily adsorbed onto the lens assembly, resulting in an accident of laser burning the sapphire lens 433. Therefore, the present invention adds a cleaning and sealing mechanism for the sapphire lens 433, mainly including a liquid cleaning module, a gas cleaning module, and a sealing module.

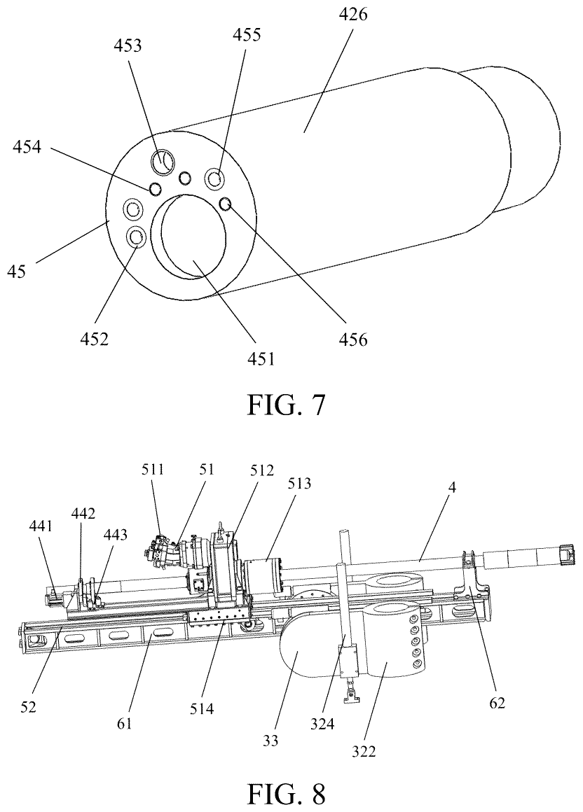

In some implementations of the present invention, as shown in FIG. 6 and FIG. 7, the liquid cleaning module mainly includes a washing water nozzle 438, a cleaning water pipe 455, and a water tank pump 464.

The water tank pump 464 is configured to hold and pressurize liquid. The cleaning water pipe 455 is mounted in the second-level inner rod 426 and the inner rod variable-diameter section 425 and is connected to the washing water nozzle 438 through the support ring 428.

Further, a spraying direction of the washing water nozzle 438 faces the laser head 431, so that the liquid sprayed through the washing water nozzle 438 is specifically sprayed to the laser head 431, thereby improving the cleaning effect.

In some implementations of the present invention, as shown in FIG. 6 and FIG. 7, the gas washing module mainly includes a washing gas nozzle 439, a cleaning gas pipe 456, and a gas pump 461. The gas pump 461 is configured to generate and pressurize gas, and the cleaning gas pipe 456 is mounted in the second-level inner rod 426 and the inner rod variable-diameter section 425 and is connected to the washing gas nozzle 439 through the support ring 428.

Further, a spraying direction of the washing gas nozzle 439 faces the laser head 431, so that the gas sprayed through the washing gas nozzle 439 is specifically sprayed to the laser head 431, thereby improving the cleaning effect.

In some implementations of the present invention, first, the liquid sprayed through the washing water nozzle 438 is used for washing the sapphire lens 433 to remove dust and impurities on the sapphire lens 433, and then, the gas sprayed through the washing gas nozzle 439 is used for cleaning the sapphire lens 433 to remove water stains adsorbed on the sapphire lens 433.

The sealing module is arranged outside the sapphire lens to play a role in sealing the laser head protection device.

In some implementations of the present invention, as shown in FIG. 4 and FIG. 7, a laser pipeline is arranged by using a laser device 462, a laser fiber 453, and the laser head 431. The laser device 462 generates high-energy laser, and the high-energy laser is transmitted through the laser fiber 453. The laser fiber 453 is arranged in the second-level inner rod 426 and the inner rod variable-diameter section 425 and is connected to the laser head 431 through the support ring 428.

In some implementations of the present invention, as shown in FIG. 4 and FIG. 7, a gas pipeline includes a gas pump 461, a high-pressure gas pipe 454, and a cylinder gas pipe 435. The gas pump 461 generates high-pressure gas, and the high-pressure gas is transmitted through the high-pressure gas pipe 454. The high-pressure gas pipe 454 is arranged in the second-level inner rod 426 and the inner rod variable-diameter section 425 and is connected to the cylinder gas pipe 435 through the support ring 428. The high-pressure gas outputted through the cylinder gas pipe 435 drives the cylinder 436 to reciprocate.

In some implementations of the present invention, as shown in FIG. 4 and FIG. 7, the slag discharging liquid pipeline includes a water pump tank 463, a slag discharging water pipe 451, and the water outlet holes 413. The water pump tank 463 is configured to hold and pressurize liquid. The pressurized liquid is transmitted into the slag discharging water pipe 451. The slag discharging water pipe 451 is arranged in the second-level inner rod 426 and the inner rod variable-diameter section 425 and is transmitted to the outside of the laser head protective shell through the support ring 428. The liquid is finally outputted through the water outlet holes 413 and carries rock slag and rock debris to return from the outside of the first-level outer rod 421, so as to achieve a cyclic slag discharging function.

Further, a plug structure 45 is arranged at a tail end of the second-level inner rod 426 to construct a sealed environment to prevent pressure release of a drilling fluid.

In some implementations of the present invention, as shown in FIG. 1 and FIG. 8, the drilling tool carrying device 6 includes a feeding frame 61 and a centralizer 62. The power head pedestal 514 is slidably connected to the feeding frame 61 and is configured to drive the laser-mechanical combined drilling tool 4 to feed forward and move backward along the feeding frame 61. The centralizer 62 is arranged at a front end of the feeding frame 61 and is configured to clamp and centralize the laser-mechanical combined drilling tool 4, thereby reducing the cantilever length of the laser-mechanical combined drilling tool 4 during drilling, and ensuring the drilling accuracy and drilling stability of the laser-mechanical combined drilling tool 4.

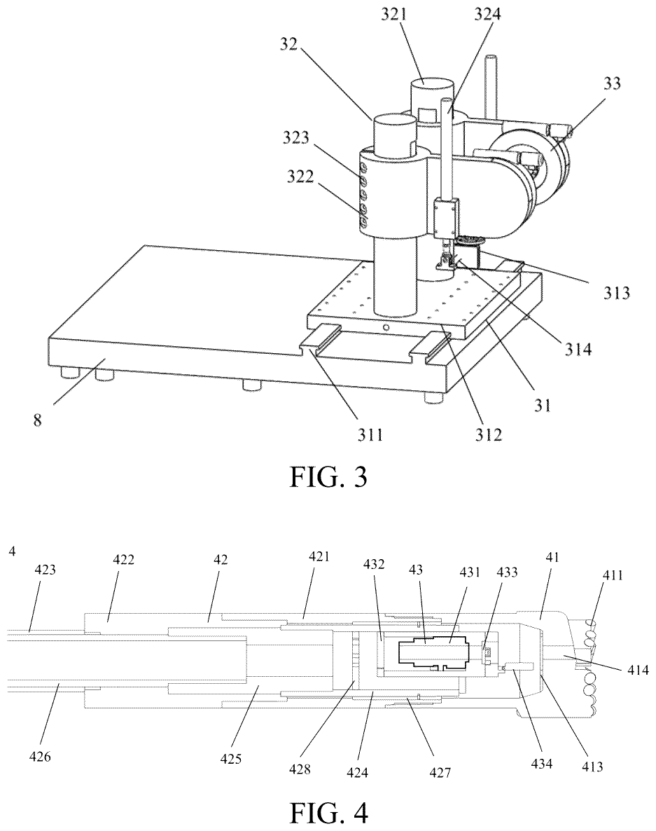

In some implementations of the present invention, as shown in FIG. 1, FIG. 3 and FIG. 8, the position adjusting device 3 includes an angle adjusting module 33. A first end of the angle adjusting module 33 is connected to the feeding frame 61, and a second end is connected to a guide sleeve 322. The angle adjusting module 33 can drive the drilling tool carrying platform 6 to achieve angle adjustment, so as to achieve relative drilling angle adjustment of the laser-mechanical combined drilling tool 4 relative to the rock sample 21.

In some implementations of the present invention, as shown in FIG. 1 and FIG. 3, the position adjusting device 3 includes a vertical position adjusting mechanism 32. The vertical position adjusting mechanism 32 includes an upright post 321, the guide sleeve 322, bolt holes 323, and a vertical adjusting oil cylinder 324. Two upright posts 321 are connected to a sliding seat 312. The guide sleeve 322 sleeves the upright post 321. A first end of the guide sleeve 322 is connected to the angle adjusting module 33. The vertical loading oil cylinder 324 is connected to the angle adjusting module 33. The guide sleeve 322 can be driven to move vertically along the upright post 321 under a pushing effect of the vertical loading oil cylinder 324. After the guide sleeve 322 moves to a designated position, the vertical loading oil cylinder 324 can be self-locked. To ensure the stability during a drilling test, secondary bolt fixation can be performed by the bolt holes 323 in the guide sleeve 322.

In some implementations of the present invention, as shown in FIG. 1 and FIG. 3, the position adjusting device 3 includes a base 8 and a horizontal position adjusting mechanism 31. The horizontal position adjusting mechanism 31 includes a T-shaped groove 311, the sliding seat 312, a horizontal adjusting motor 313, and a lead screw 314.

The base 8 is arranged inside a foundation pit 9 to enable a testing device to sink below a plane of the foundation basis 1, thereby reducing the hoisting height of the rock sample 21, and reducing the hoisting risk. The T-shaped groove 311 is arranged on the base 8. An upper end of the T-shaped groove 311 is connected to the sliding seat 312. One side of the sliding seat 312 is connected to the horizontal adjusting motor 313 and the lead screw 314. The lead screw 314 is driven to rotate under the driving of the horizontal adjusting motor 313, so as to achieve horizontal movement of the sliding seat 312 along the T-shaped groove 311. The lead screw 314 has a self-locking function and can be self-locked and fixed after the sliding seat 312 moves to a designated position.

In some implementations of the present invention, as shown in FIG. 1, an oil source pump station 7 includes a pump station 71 and an oil cooler 72. The pump station 71 provides a driving force for the driving device 5, and the oil cooler 72 cools the pump station 71, thereby ensuring the stable operation of the pump station 71.

In some implementations of the present invention, as shown in FIG. 1, the laser-mechanical combined efficient drilling and rock breaking platform simulation test system includes a control cabinet 10. Each channel of the control cabinet 10 has the function of force closed-loop, displacement closed-loop, rotation angle closed-loop, and rotation speed closed-loop control, and multiple channels of signals of the system are acquired and processed, thereby achieving unified coordinated control of the confining pressure loading device 2, the position adjusting device 3, and the driving device 5 of the laser-mechanical combined efficient drilling and rock breaking platform simulation test system.

### Example 2

Example 2 of the present invention provides a simulating and testing method for laser-mechanical combined efficient drilling and rock breaking. By using the simulating and testing platform system for laser-mechanical combined efficient drilling and rock breaking described in Example 1, the method includes:
(1) The openable baffle 434 in the laser-mechanical combined drilling tool 4 is closed, the laser head 43 is in a sealed protection state, and laser irradiation is not performed. In this case, the driving device 5 drives the drill rod 42 to drive the drill bit 41 to perform mechanical cutting for drilling and rock breaking, and slag discharging liquid is introduced into the slag discharging water pipe 451 for discharging slag, so as to achieve a purely mechanical drilling and rock breaking test.
(2) The driving device 5 stops working, high-pressure gas is introduced into the gas pump 461 and enters the cylinder 436 through the high-pressure gas pipe 435 to push the cylinder push rod 437 to open the openable baffle 434, and only the laser device 462 is turned on to perform a laser rock breaking test.

More specifically, the method includes:
First, the openable baffle 434 is closed, the laser head 43 is in a sealed protection state, the driving device 5 drives the drill rod 42 to drive the drill bit 41 to perform mechanical cutting for drilling and rock breaking, and slag discharging liquid is introduced into the slag discharging water pipe 451 for discharging slag; the driving device 5 stops working after the drill bit 41 drills to a designated position, the laser-mechanical combined drilling tool 4 stops rotating, and the water pump 463 is turned off to stop introducing the slag discharging liquid.

The gas pump 461 is turned on to introduce high-pressure gas, the high-pressure gas enters the cylinder 436 through the high-pressure gas pipe 435 to push the cylinder push rod 437 to open the openable baffle 434, the sapphire lens 433 is cleaned through the washing water nozzle 438, dust adhered to the sapphire lens 433 is rinsed, then the water pump is turned off, the washing water nozzle 438 stops rinsing, the gas pump 431 is turned on, and water droplets on the sapphire lens 433 are blown off through the washing gas nozzle 439, thereby ensuring that the sapphire lens 433 is in a clean and dry state.

Then, the laser device 462 is turned on to perform a laser rock breaking test; and the above steps are repeated to finally achieve a laser-mechanical combined drilling and rock breaking test.

During a rock breaking test, a confining pressure can be applied to simulate a real drilling terrestrial stress environment, which includes:
the rock sample 21 is hoisted to the sample base 22 and moved into the confining pressure loading rock box 24 through the sample adjusting device 23; and when the laser-mechanical combined drilling tool 4 performs a drilling and rock breaking test, the confining pressure loading oil cylinder 25 applies confining pressures with predetermined magnitudes to the rock sample 21 to simulate terrestrial stress situations at different burial depths.

To verify the superiority and engineering practicability of a laser-assisted mechanical drilling tool for drilling, the above testing method for laser-mechanical combined efficient drilling and rock breaking can be compared with a testing method for mechanical-drilling-tool-used-only drilling and rock breaking, which includes:
(1) A rock breaking test is performed according to a constant torque and pushing force, and a laser-mechanical combined drilling and rock breaking rate is compared with a drilling rate obtained by using only the mechanical drilling tool to research the superiority of the combined drilling speed:
   oil pressure sensors are arranged in the hydraulic motor 511 and the pushing force loading oil cylinder 52, a displacement sensor is arranged between the power head pedestal 514 and the centralizer 62 to monitor the displacement variation, pushing force and torque in real time during the drilling process of the drilling rig; the pushing force loading oil cylinder 52 sets a constant pushing force applied to the laser-mechanical combined drilling tool 4, and the rotation loading module 51 sets a constant torque; the laser device 462 is turned on and cooperates with the drill bit 41 to perform a laser-mechanical combined drilling test, so as to obtain a drilling rate under the combined drilling test; the laser device 462 is turned off, and only the drill bit 41 is used for performing a mechanical drilling test, so as to obtain a drilling rate under the mechanical drilling test; and the drilling rates in the two drilling modes are compared to research the superiority of combined drilling under the assistance of laser.
(2) A rock breaking test is performed according to a constant rotation speed and pushing speed, and the pushing force and torque required for laser-mechanical combined drilling and rock breaking are compared with that required for drilling and rock breaking using only a mechanical drilling tool to research the engineering practicability of combined drilling:
   the pushing force loading oil cylinder 52 and the rotation loading module 51 set a constant rotation speed and pushing speed of the drill bit 41, and the laser device 462 is controlled to be turned on and off to achieve a laser-mechanical combined drilling test and a drilling test using a mechanical drilling tool; oil pressure sensors are arranged in the hydraulic motor 511 of the rotation loading module 51 and the pushing force loading oil cylinder 52, and a displacement sensor is arranged between the power head pedestal 514 and the centralizer 62 to monitor the displacement variation, pushing force and torque in real time during the drilling process of the drilling rig; and the rock breaking pushing force and torque required for laser-mechanical combined drilling are compared with that required for mechanical drilling using only the drill bit 41 to research the engineering practicability of combined drilling under the assistance of laser.

In the above test method, different models of laser heads 43 can be replaced to change the energy distribution form of laser; the relative position between the laser head 43 and the drill bit 41 can be changed to adjust the light spot diameter; the type of the laser device 462 can be switched to achieve the conversion between continuous laser and pulsed laser; the laser device 462 can be adjusted to set different laser rock breaking parameters and change parameters such as materials, structures and sizes of the drill bit 41 and the drill rod in the laser-mechanical combined drilling tool 4, so as to increase the diversity of the drilling and rock breaking test.

In the present embodiment, the laser-mechanical combined drilling tool 4 and the driving device 5 both adopt a modular design, and different laser-mechanical combined drilling tools 4 and driving devices 5 can be replaced to achieve laser-mechanical combined drilling and rock breaking tests of different models and parameter ranges. In addition, the structural design of the laser-mechanical combined drilling tool 4 is continuously optimized by tests, thereby providing a testing device basis for the function test of the laser-mechanical combined drilling tool 4.

The above descriptions are only preferred embodiments of the present invention and are not intended to limit the present invention, and those skilled in the art can make various modifications and changes to the present invention. Any modifications, equivalent replacements, improvements and the like made within the spirit and principle of the present invention shall fall within the scope of protection of the present invention.

1-13. (canceled)

14. A simulating and testing platform system for laser-mechanical combined efficient drilling and rock breaking, comprising:
a confining pressure loading device, configured to perform sample positioning, clamping and confining pressure loading;
a laser-mechanical combined drilling tool, configured to perform laser-mechanical combined drilling; wherein, the laser-mechanical combined drilling tool comprises a drill rod; wherein,
the drill rod comprises a first-level outer rod, an outer rod variable-diameter section, a second-level outer rod, a first-level inner rod, an inner rod variable-diameter section, a second-level inner rod, a wear-resistant copper sleeve, and a support ring; and
the first-level outer rod is connected to the second-level outer rod through the outer rod variable-diameter section, the first-level inner rod is connected to the second-level inner rod through the inner rod variable-diameter section, an inner diameter of the second-level outer rod is less than an inner diameter of the first-level outer rod, an inner diameter of the second-level inner rod is less than an inner diameter of the first-level inner rod, the first-level outer rod sleeves outside the first-level inner rod, the wear-resistant copper sleeve is connected between the first-level outer rod and the first-level inner rod, and the support ring is arranged in the first-level inner rod;
a driving device, configured to drive the laser-mechanical combined drilling tool to perform combined drilling;
a drilling tool carrying device, configured to carry the laser-mechanical combined drilling tool and the driving device; and
a position adjusting device, configured to be connected to the drilling tool carrying device, and adjust a relative position between the laser-mechanical combined drilling tool and a sample to change a drilling angle of the laser-mechanical combined drilling tool.

15. The simulating and testing platform system for laser-mechanical combined efficient drilling and rock breaking according to claim 14, wherein
the confining pressure loading device comprises a sample base, a sample adjusting device, a confining pressure loading rock box, and a confining pressure loading mechanism; and
the sample base is configured to bear the sample, the sample adjusting device is configured to push the sample to a designated position of the confining pressure loading rock box, and the confining pressure loading mechanism is configured to clamp and fix the rock sample and apply a pressure to the rock sample.

16. The simulating and testing platform system for laser-mechanical combined efficient drilling and rock breaking according to claim 14, wherein
the driving device comprises a rotation loading module and a pushing force loading mechanism;
the rotation loading module comprises a hydraulic motor, a reduction gearbox, a drill rod clamping device, and a power head pedestal, the drill rod clamping device is configured to be connected to the laser-mechanical combined drilling tool, the hydraulic motor is connected to the drill rod clamping device through the reduction gearbox, and the reduction gearbox and the drill rod clamping device are both connected to the power head pedestal;
a first end of the pushing force loading mechanism is connected to the drilling tool carrying device, a second end of the pushing force loading mechanism is connected to the power head pedestal, and the pushing force loading mechanism is configured to apply a pushing force to act on the power head pedestal to push the power head pedestal for feeding, so as to drive the laser-mechanical combined drilling tool to advance for rock breaking;
the drilling tool carrying device comprises a feeding frame and a centralizer;
the power head pedestal is slidably connected to the feeding frame and is configured to drive the laser-mechanical combined drilling tool to feed forward and move backward along the feeding frame; and the centralizer is fixed at a front end of the feeding frame and is configured to clamp and centralize the laser-mechanical combined drilling tool.

17. The simulating and testing platform system for laser-mechanical combined efficient drilling and rock breaking according to claim 14, wherein
the position adjusting device comprises an angle adjusting module, a vertical position adjusting mechanism, a base, and a horizontal position adjusting mechanism;
a first end of the angle adjusting module is connected to the feeding frame, a second end is connected to a guide sleeve, and the angle adjusting module is configured to drive the drilling tool carrying device to achieve angle adjustment, so as to achieve relative drilling angle adjustment of the laser-mechanical combined drilling tool relative to the rock sample;
the vertical position adjusting mechanism comprises an upright post, the guide sleeve, bolt holes, and a vertical adjusting oil cylinder;
the upright post is connected to a sliding seat, the guide sleeve sleeves the upright post, a first end of the guide sleeve is connected to the angle adjusting module, the vertical loading oil cylinder is connected to the angle adjusting module, and the guide sleeve is driven to move vertically along the upright post under a pushing effect of the vertical loading oil cylinder;
after the guide sleeve moves to a designated position, the vertical loading oil cylinder is self-locked, and the bolt holes in the guide sleeve are configured to perform secondary bolt fixation;
the horizontal position adjusting mechanism comprises a sliding chute, the sliding seat, a horizontal adjusting motor, and a lead screw, and the base is configured to be arranged inside a foundation pit to enable a testing device to sink below a plane of a foundation basis;
the sliding chute is fixed on the base, an upper end of the sliding chute is connected to the sliding seat, one side of the sliding seat is connected to the horizontal adjusting motor through the lead screw, and the lead screw is driven to rotate under the driving of the horizontal adjusting motor to enable the sliding seat to move horizontally along the sliding chute; and
the lead screw is configured to have a self-locking function, and after the sliding seat moves to a designated position, the lead screw is self-locked and fixed.

18. The simulating and testing platform system for laser-mechanical combined efficient drilling and rock breaking according to claim 14, wherein
the laser-mechanical combined drilling tool further comprises a drill bit; wherein,
the drill bit comprises cutting teeth, reinforcing teeth, water outlet holes, and a light outlet hole, the drill bit is of a multi-wing PDC composite drill bit structure, the cutting teeth of each wing are arranged in a streamlined tooth pattern, and the reinforcing teeth are arranged in a back row of the cutting teeth of each wing; and
the water outlet holes are formed between adjacent wings of the drill bit, a laser light outlet hole is formed at a position deviating from a center of the drill bit, and the cutting teeth are arranged at the center of the drill bit.

19. The simulating and testing platform system for laser-mechanical combined efficient drilling and rock breaking according to claim 14, wherein
the laser-mechanical combined drilling tool further comprises an inner rod fine-adjusting mechanism; and
the inner rod fine-adjusting mechanism comprises a servo motor, a synchronous pulley, and an absolute value encoder, the second-level inner rod is connected to the servo motor through the synchronous pulley, and the absolute value encoder is mounted on the synchronous pulley and is configured to record a rotation angle of the second-level inner rod in real time to adjust a rotation angle of a laser head, so as to align a laser beam with the light outlet hole of the drill bit.

20. The simulating and testing platform system for laser-mechanical combined efficient drilling and rock breaking according to claim 14, wherein
the laser-mechanical combined drilling tool further comprises a laser head assembly;
the laser head assembly comprises a laser head protection device;
the laser head protection device comprises a laser head protective shell, a sapphire lens, an openable baffle, a cylinder, and a cylinder push rod; and
the laser head is fixed in the laser head protective shell, the sapphire lens is mounted outside the laser head for first-level protection, the openable baffle is mounted outside the sapphire lens, the openable baffle drives the cylinder push rod to reciprocate through the cylinder to achieve opening and closing actions, and the openable baffle constitutes second-level protection.

21. The simulating and testing platform system for laser-mechanical combined efficient drilling and rock breaking according to claim 20, wherein
the laser head protection device further comprises a liquid cleaning module and a gas washing module;
the liquid cleaning module comprises a washing water nozzle, a cleaning water pipe, and a water tank pump;
the water tank pump is configured to hold and pressurize liquid, a first end of the cleaning water pipe is connected to the water pump, the cleaning water pipe is mounted in the second-level inner rod and the inner rod variable-diameter section, a second end of the cleaning water pipe is connected to the washing water nozzle through the support ring, and a spraying direction of the washing water nozzle faces the laser head;
the gas washing module comprises a washing gas nozzle, a cleaning gas pipe, and a gas pump; and
the gas pump is configured to generate and pressurize gas, a first end of the cleaning gas pipe is connected to the gas pump, the cleaning gas pipe is mounted in the second-level inner rod and the inner rod variable-diameter section, a second end of the cleaning gas pipe is connected to the washing gas nozzle through the support ring, and a spraying direction of the washing gas nozzle faces the laser head.

22. The simulating and testing platform system for laser-mechanical combined efficient drilling and rock breaking according to claim 20, wherein
the laser head protection device further comprises a sealing module; and
the sealing module is arranged outside the sapphire lens and is configured to seal the laser head protection mechanism.

23. The simulating and testing platform system for laser-mechanical combined efficient drilling and rock breaking according to claim 14, wherein,
further comprising: a slag discharging liquid pipeline;
the slag discharging liquid pipeline comprises: a water pump tank, a slag discharging water pipe, and water outlet holes; wherein
a first end of the slag discharging water pipe is connected to the water pump tank, and the slag discharging water pipe is arranged in the second-level inner rod and the inner rod variable-diameter section, and is transmitted to the outside of a laser head protective shell through the support ring and then connected to the water outlet holes, so as to enable the liquid to be discharged through the water outlet holes and then carry rock slag and rock debris to return from the outside of the first-level outer rod.

24. A testing method, applying to the simulating and testing platform system for laser-mechanical combined efficient drilling and rock breaking according to claim 21, and comprising the following steps:
closing an openable baffle, a laser head being in a sealed protection state, driving a drill rod through a driving device to drive a drill bit to perform mechanical cutting for drilling and rock breaking, introducing slag discharging liquid into a slag discharging water pipe for discharging slag, stopping the driving device after the drill bit drills to a designated position, enabling a laser-mechanical combined drilling tool to stop rotating, and turning off a water pump to stop introducing the slag discharging liquid;
opening the openable baffle, cleaning a sapphire lens through a washing water nozzle, rinsing dust adhered to the sapphire lens, then turning off the water pump to enable the washing water nozzle to stop rinsing, turning on a gas pump, blowing off water droplets on the sapphire lens through a washing gas nozzle, and then turning on a laser device to perform a laser rock breaking test; and
repeating the processes to achieve a laser-mechanical combined drilling and rock breaking test.

25. The testing method according to claim 24, wherein
a rock sample is hoisted to a sample base and moved into a confining pressure loading rock box through a sample adjusting device, and when the laser-mechanical combined drilling tool performs a drilling and rock breaking test, a confining pressure loading mechanism applies confining pressures with predetermined magnitudes to the rock sample to simulate terrestrial stress situations at different burial depths.
